(19) United States
(12) Patent Application Publication
(10) Pub. No.: US 2010/0002318 A1
(43) Pub. Date: Jan. 7, 2010

(54) BRIGHTNESS ENHANCEMENT PANEL AND DISPLAY DEVICE HAVING SAME

(75) Inventor: TSUNG-YU LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/434,666

(22) Filed: May 3, 2009

(30) Foreign Application Priority Data
Jul. 4, 2008 (CN) 200810302528.9

(51) Int. Cl. G02B 5/04

(52) U.S. Cl. 359/831

(57) ABSTRACT

A display device includes a display panel and a brightness enhancement panel. The display panel has a light output surface. The brightness enhancement panel is mounted on the light output surface. The brightness enhancement panel includes a base plate portion and a plurality of quadrilateral pyramid lens portions. Each of the lens portions defines a square base and four substantially identical triangular sides. The base plate portion has two opposite sides. One of the two sides of the base plate portion abuts the light output surface and the lens portions are arranged at the other side of the base plate portion.

### BACKGROUND

1. Technical Field

The disclosure relates generally to a display device having a brightness enhancement panel.

2. Description of Related Art

In general, an LCD (liquid crystal display) apparatus has many advantages over a CRT (Cathode Ray Tube) display apparatus, particularly in respect of weight and size. These advantages derive from the LCD's use of liquid crystal for providing images. The liquid crystal is controlled by an electric field. Under an applied electric field, liquid crystal molecules are oriented in a predetermined direction parallel to a direction of the electric field. Light transmittance for providing images varies according to the orientations of the liquid crystal molecules.

The LCD apparatus may include a backlight module and an LCD panel. The backlight module is used to illuminate the LCD panel. The LCD panel includes two light-pervious plates and an LC layer sandwiched between the two light-pervious plates.

One of the two light-pervious plates is adjacent to the backlight module and the other is farther away from the backlight module. Light transmitted through the LC layer exits from the light-pervious plate farther away from the backlight module. Usually, the light-pervious plate is made of glass or plastic. The refractive indexes of glass and plastic are both greater than the refractive index of air. When light rays are transmitted through the light-pervious plate, some of the light rays are totally reflected at the interface between the light-pervious plate and the exterior, and may be substantially dissipated in the light-pervious plate. Thus, the brightness of the light exiting from the light-pervious plate is reduced.

Therefore, a display device is needed to overcome the above shortcomings.

### BRIEF DESCRIPTION OF THE DRAWINGS

The components in the drawings are not necessarily drawn to scale, the emphasis instead being placed upon clearly illustrating the principles of the present embodiments.

FIG. 1 is a schematic, isometric view of a brightness enhancement panel in accordance with a first embodiment, the brightness enhancement panel including a plurality of pyramid-shaped micro-lenses.

FIG. 2 is a cross-sectional view taken along line II-II of FIG. 1.

FIG. 3 is cross-sectional view of a brightness enhancement panel with each two pyramid-shaped micro-lenses adjoining each other.

FIG. 4 is a schematic, isometric view of a display device incorporating the brightness enhancement panel as shown in FIG. 1.

FIG. 5 is an enlarged, schematic side view showing light paths at three pixel areas of a display device (hereinafter, “control display device”) similar to the display device of FIG. 4, the control display device not having the brightness enhancement panel of FIG. 1.

FIG. 6 is similar to FIG. 5, but showing light paths at three pixel areas of the display device of FIG. 4.

FIG. 7 is an optical simulation diagram of a pattern displayed by the control display device.

FIG. 8 is an optical simulation diagram of a pattern displayed by the display device of FIG. 4, in the case where an angle formed by the base and each side of each pyramid-shaped micro-lens is about 30 degrees.

FIG. 9 is similar to FIG. 8, but showing a pattern in the case where the angle formed by the base and each side of each pyramid-shaped micro-lens is about 45 degrees.

FIG. 10 is similar to FIG. 8, but showing a pattern in the case where the angle formed by the base and each side of each pyramid-shaped micro-lens is about 60 degrees.

Corresponding reference characters indicate corresponding parts. The exemplifications set out herein illustrate at least one embodiment of the present display device having a brightness enhancement panel, in one form, and such exemplifications are not to be construed as limiting the scope of the invention in any manner.

### DETAILED DESCRIPTION

Reference will now be made to the drawings to describe various embodiments of the present display device having a brightness enhancement panel.

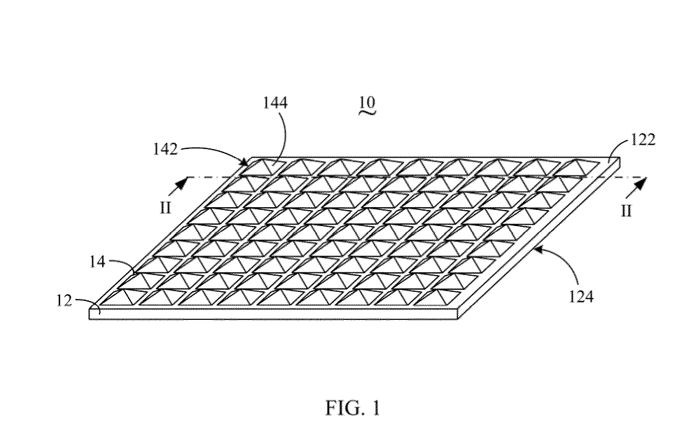

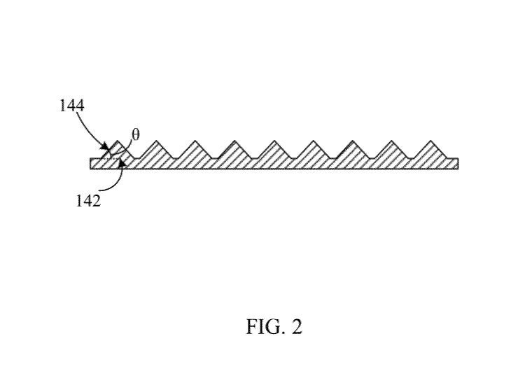

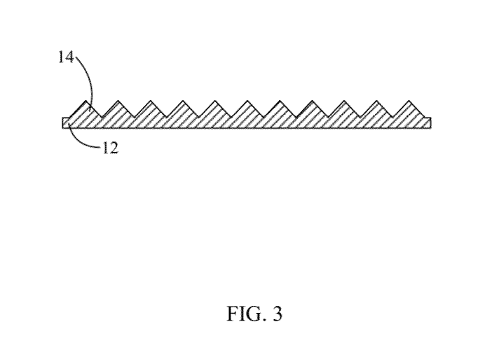

Referring to FIG. 1, a brightness enhancement panel 10 is provided in accordance with an exemplary embodiment. The brightness enhancement panel 10 includes a base plate 12, and a plurality of identical quadrilateral pyramid lenses 14 formed at a top surface 122 of the base plate 12. The lenses 14 are arranged in rows and columns. In this embodiment, the lenses 14 are spaced equal distances apart from each other. Also, each two adjacent lenses 14 can adjoin each other as shown in FIG. 3. The lenses 14 are integrally formed with the base plate 12. That is, the brightness enhancement panel 10 is a single body of material comprising the base plate 12 and the lenses 14. Each lens 14 defines a square base 142 and four isosceles triangular sides 144 to form the pyramid shape. Referring also to FIG. 2, the base 142 forms an angle θ with each side 144.

The base plate 12 and the lenses 14 may be made of plastic material such as polymethyl methacrylate (PMMA). In one embodiment, the brightness enhancement panel 10 is attached on a light-pervious plate of a display device, with a refractive index of the light-pervious plate being substantially equal to the common refractive index of the base plate 12 and the lenses 14.

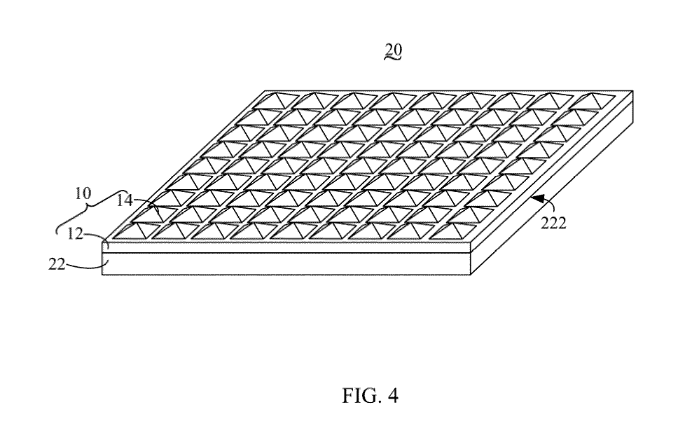

Referring also to FIG. 4, a display device 20 utilizing the brightness enhancement panel 10 is provided. The display device 20 includes a display panel 22 and the brightness enhancement panel 10. The display panel 22 may for example be an LCD panel or a light-emitting diode display panel. The display panel 22 has a light output surface 222. Light in the display panel 22 is transmitted out through the light output surface 222. The base plate 12 of the brightness enhancement panel 10 also has a bottom surface 124 facing away from the top surface 122. The brightness enhancement panel 10 is glued (adhered) on the display panel 22 so that the bottom surface 124 of the base plate 12 is attached on the light output surface 222 of the display panel 22.

The brightness enhancement panel 10 in this embodiment includes a multiplicity of the lenses 14. The four sides 144 of the lenses 14 provide decreased incidence angles of the light striking thereat, compared to the situation where there is no brightness enhancement panel 10 and the light must strike the interface between the output surface 222 of the display panel 22 and the exterior. Thus in the present embodiment, more of the light exiting through the light output surface 222 is able to proceed to exit from the top of the display device 20. That is, there is reduced internal reflection of the light transmitting in the display panel 22, so that the effective brightness of the display panel 22 is enhanced. In general, the brightness of the display panel 22 increases along with an increase in the angle θ of each of the lenses 14.

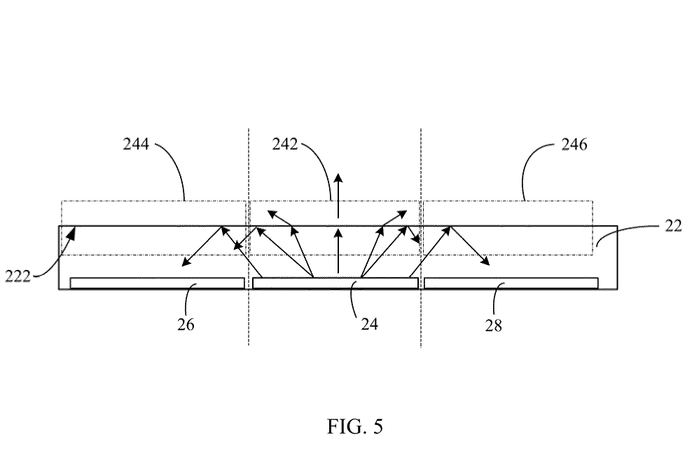

On the other hand, image blurring may be caused by too great of an angle θ between the base 142 and each of the sides 144 in each of the lenses 14. Referring to FIGS. 5 to 10, the cause of the image blurring and a solution for controlling the image blurring to be in an acceptable range are described in detail below.

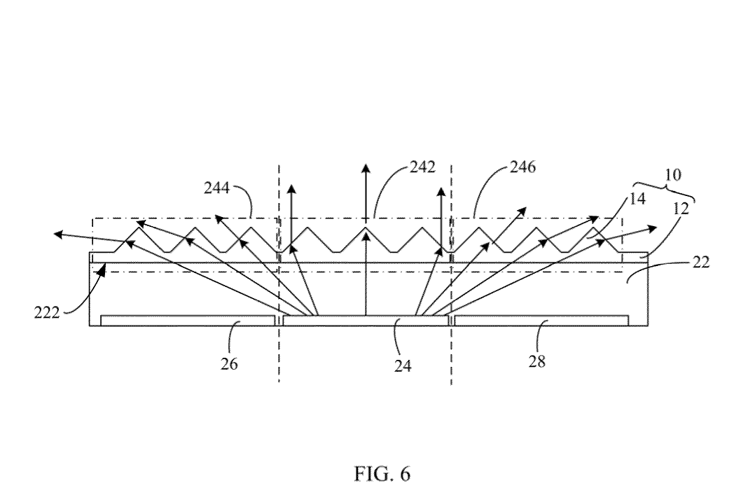

Referring to FIGS. 5 and 6, a plurality of pixel areas (or “pixels”), such as pixels 24, 26 and 28, are included in the display panel 22. In this embodiment, in each group of three pixels 24, 26, 28, the pixels 26 and 28 are arranged at opposite sides of the pixel 24. The pixels 24, 26 and 28 can emit light towards the light output surface 222. For ease of description, only light from the pixels 24 is discussed below. As shown in FIGS. 5 and 6, the light output surface 222 can be divided into a plurality of regions, such as a region 242 facing towards the pixel 24, a region 244 facing towards the pixel 26, and a region 246 facing towards the pixel 28. Referring to FIG. 5, in the case of a display device (hereinafter, “control display device”) which has only the display panel 22 and no brightness enhancement panel 10, the light reaching the region 242 is transmitted out of the light output surface 222. Some of the light reaching the region 242 and almost all the light reaching the regions 244 and 246 is totally internally reflected at the light output surface 222.

As shown in FIG. 6, when the brightness enhancement panel 10 is mounted on the light output surface 222, the light emitted from the pixel 24 strikes the output surface 222 and then transmits into the brightness enhancement panel 10. Because of the lenses 14, some light reaching the regions 244 and 246 is transmitted through the sides 144 of the lenses 14. Thus, image blurring occurs on the regions 244 and 246.

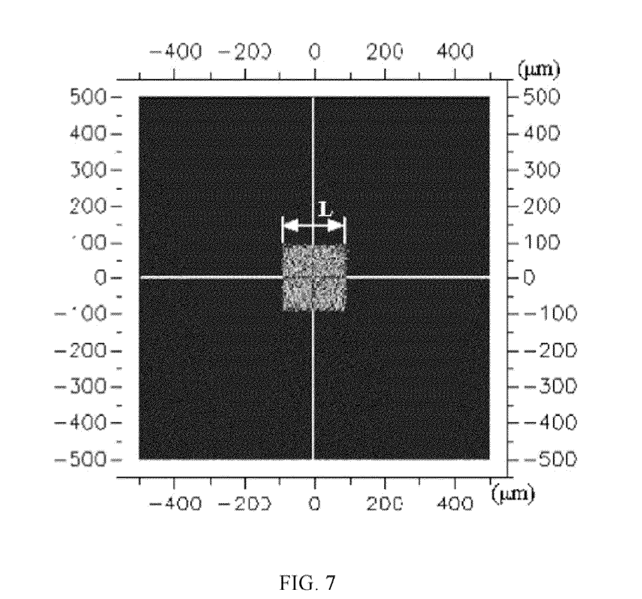

Referring to FIG. 7, this is an optical simulation diagram of a pattern displayed by the control display device; i.e., by the display panel 22 only, without the brightness enhancement panel 10. In this case, a square image 26 corresponding to the pixel 24 is shown on the output surface 222 without blurring.

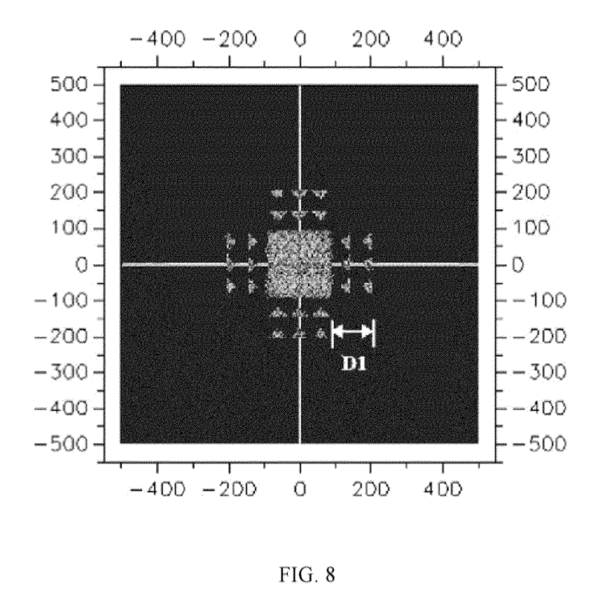

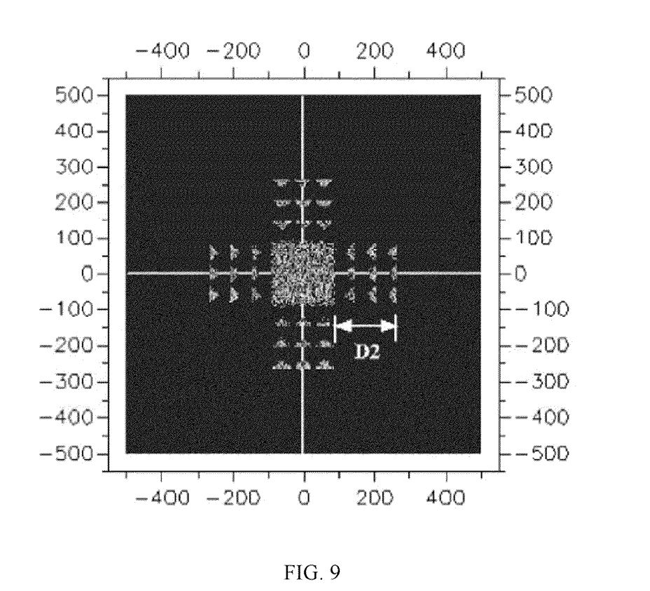

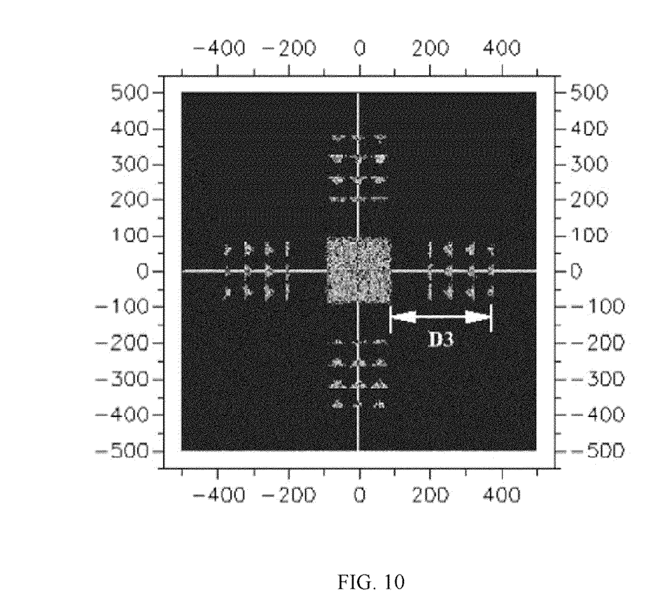

Referring to FIGS. 8-10, these are optical simulation diagrams for the display device 20; i.e., with the brightness enhancement panel 10 mounted on the output surface 222. FIG. 8 is an optical simulation diagram when the angle θ between the base 142 and each side 144 is about 30 degrees, FIG. 9 is an optical simulation diagram when the angle θ is about 45 degrees, and FIG. 10 is an optical simulation diagram when the angle θ is about 60 degrees. In this embodiment, the mottled square image in the very center of each of FIGS. 7-10 has four sides, each with a length L=177 microns. The base 142 of each lens 14 has four sides each with a length of 50 microns. A distance between each two adjacent lenses 14 is 7.7 microns.

An area of the display with the greatest luminous intensity is the mottled square image, and this area is defined as Iₘ. An area around the mottled square image having a luminous intensity equal to or greater than

$$\frac{1}{{e}^{2}} * ( {I}_{m} ) ,$$

plus the area of the mottled square image itself, is defined as an effective luminous extent of the mottled square image. In other words, areas near the mottled square image that are almost as bright as the mottled square image cause the mottled square image to appear blurred. A width of the effective luminous extent is defined as a width L1. Thus a blur width D on the display device 20, as measured from any side of the mottled square image to the nearest outmost extremity of the effective luminous extent, is defined as follows: D=(L1−L)/2. If there is no blurred area, then L1 equals L.

The optical simulation diagrams of FIGS. 8 to 10 show the blur widths D on the display device 20 when the angle θ is 30 degrees, 45 degrees, and 60 degrees, respectively. As shown in FIG. 8, when the angle θ is 30 degrees, a blur width D1 is about 107.5 microns. As shown in FIG. 9, when the angle θ is 45 degrees, a blur width D2 is about 167.5 microns. As shown in FIG. 10, when the angle θ is 60 degrees, a blur width D3 is about 282.5 microns.

It is clear then, that the brightness of the display device 20 increases and the blur width D becomes larger with the increasing of the angle θ. The blurred image should be controlled in an acceptable range. In other words, the blur width should be lower than a predetermined threshold value. In order to obtain a large enough brightness and control the blur width in an acceptable range, the angle θ should be properly selected. For different types of display devices, the acceptable ranges of blurring may differ. For example, when a pixel size is in a range from 177 microns×177 microns to 5000 microns×5000 microns, and a distance between two adjacent pixels is in a range from 35 microns to 177 microns, then the angle θ between the base 142 and each of the sides 144 of each quadrilateral pyramid lens 14 is preferably in the range: 30 degrees≦θ<90 degrees. In addition, when the brightness enhancement panel 10 is mounted on the display panel 22, a length of each edge of each base 142 should be less than that of each pixel. In this embodiment, one pixel corresponds to two or more lenses 14.

In this embodiment, because the brightness enhancement panel 10 includes the plurality of lenses 14, more light rays at the light output surface 222 of the display device 20 are able to proceed to transmit out of the top of the display device 20. Thus the brightness of the display device 20 is enhanced. In addition, the amount of blurring can be controlled by appropriately selecting the angle θ between the base 142 and each side 144 of each of the lenses 14. Thus the brightness enhancement panel 10 is easily adapted for different types of display devices such as the display device 20.

Finally, it is to be understood that the above-described embodiments are intended to illustrate rather than limit the disclosure. Variations may be made to the embodiments without departing from the spirit of the invention as claimed. The above-described embodiments illustrate the scope of the disclosure but do not restrict the scope of the disclosure.

What is claimed is:

1. A display device comprising:
a display panel having a light output surface;
a brightness enhancement panel mounted on the light output surface, the brightness enhancement panel comprising a base plate portion and a plurality of quadrilateral pyramid lens portions, each of the lens portions defining a square base and four substantially identical triangular sides, the base plate portion having two opposite sides, one of the two sides of the base plate portion abutting the light output surface, and the lens portions being arranged at the other side of the base plate portion.

2. The display device of claim 1, wherein said other side of the base plate portion has a base plate portion surface, and the base plate portion surface abuts the light output surface.

3. The display device of claim 1, wherein the lens portions are identical to each other and are arranged in rows and columns.

4. The display device of claim 3, wherein each two adjacent lens portions adjoin each other.

5. The display device of claim 3, wherein the plurality of lens portions are spaced equal distances apart from each other.

6. The display device of claim 3, wherein an angle θ between the square base and each of the triangular sides of each lens portion is in the range: 30 degrees≦θ<90 degrees.

7. The display device of claim 1, wherein the brightness enhancement panel is a single body of material comprising the base plate portion and the lens portions.

8. The display device of claim 1, wherein a material of the base plate portion and the lens portions comprises polymethyl methacrylate.

9. A brightness enhancement panel, comprising:
a base plate portion having two opposite sides; and
a plurality of quadrilateral pyramid lens portions, each of the lens portions defining a square base and four substantially identical triangular sides, the lens portions being identical to each other and regularly arranged in rows and columns at one of the two sides of the base plate portion.

10. The brightness enhancement panel of claim 9, wherein each two adjacent lens portions adjoin each other.

11. The brightness enhancement panel of claim 9, wherein the plurality of lens portions are spaced equal distances apart from each other.

12. The brightness enhancement panel of claim 9, wherein an angle θ between the square base and each of the triangular sides of each lens portion is in the range: 30 degrees≦θ<90 degrees.

13. The brightness enhancement panel of claim 9, wherein the brightness enhancement panel is a single body of material comprising the base plate portion and the lens portions.

14. The brightness enhancement panel of claim 9, wherein a material of the base plate portion and the lens portions comprises polymethyl methacrylate.
